(19) United States
(12) Patent Application Publication
(10) Pub. No.: US 2026/0175125 A1
(43) Pub. Date: Jun. 25, 2026

(54) GAME VIEW DISPLAY CONTROL

(71) Applicant: Tencent Technology (Shenzhen) Company Limited, Shenzhen (CN)

(72) Inventor: Xiaoquan HUANG, Shenzhen (CN)

(73) Assignee: Tencent Technology (Shenzhen) Company Limited, Shenzhen (CN)

(21) Appl. No.: 19/450,713

(22) Filed: Jan. 15, 2026

Related U.S. Application Data
(63) Continuation of application No. PCT/CN2024/121033, filed on Sep. 25, 2024.

(30) Foreign Application Priority Data
Dec. 19, 2023 (CN) 202311758047.X

(51) Int. Cl. A63F 13/525; A63F 13/2145; A63F 13/533; A63F 13/837

(52) U.S. Cl. CPC A63F 13/525; A63F 13/2145; A63F 13/533; A63F 13/837; A63F 2300/638

(57) ABSTRACT

In a game control method, a first virtual scene of a virtual environment is output for display according to a first field-of-view of a virtual character located in the virtual environment. It is determined that a trigger operation is performed to display a plurality of fields-of-view of the virtual character. Based on the trigger operation, a second virtual scene of the virtual environment is output for display according to a second field-of-view of the virtual character concurrently with the first virtual scene. The second field-of-view is different from the first field-of-view.

### RELATED APPLICATIONS

The present application is a continuation of International Application No. PCT/CN2024/121033, filed on Sep. 25, 2024, which claims priority to Chinese Patent Application No. 202311758047.X, filed on Dec. 19, 2023. The entire disclosures of the prior applications are hereby incorporated by reference.

### FIELD OF THE TECHNOLOGY

Aspects of this disclosure relate to the field of computer technologies, including a game control method.

### BACKGROUND OF THE DISCLOSURE

With the continuous development of computer technologies, a quantity of players playing multiplayer online battle arena (MOBA) games is increasing. In the MOBA game, a virtual environment and a virtual object in the virtual environment may be displayed. A player controls the virtual object to move in the virtual environment, and interacts with the virtual environment or another virtual player by using a virtual item.

In the MOBA game, for the player, a field of view of the virtual object in the virtual environment is a crucial attribute. The player obtains a field-of-view picture of the virtual object by controlling the virtual object to move in the virtual environment. The field-of-view picture is a picture obtained by the virtual object observing the virtual environment. The player obtains information about the virtual environment through the field-of-view picture, and makes an in-game decision based on the information about the virtual environment.

### SUMMARY

Aspects of this disclosure provide a game control method, a game control apparatus, and a non-transitory computer-readable storage medium. Examples of technical solutions of this disclosure may be implemented as follows:

An aspect of this disclosure provides a game control method. In the method, a first virtual scene of a virtual environment is output for display according to a first field-of-view of a virtual character located in the virtual environment. It is determined that a trigger operation is performed to display a plurality of fields-of-view of the virtual character. Based on the trigger operation, a second virtual scene of the virtual environment is output for display according to a second field-of-view of the virtual character concurrently with the first virtual scene. The second field-of-view is different from the first field-of-view.

An aspect of this disclosure provides a game control apparatus. The apparatus includes processing circuitry configured to output for display a first virtual scene of a virtual environment according to a first field-of-view of a virtual character located in the virtual environment. The processing circuitry is configured to determine that a trigger operation is performed to display a plurality of fields-of-view of the virtual character. Based on the trigger operation, the processing circuitry is configured to output for display a second virtual scene of the virtual environment according to a second field-of-view of the virtual character concurrently with the first virtual scene. The second field-of-view is different from the first field-of-view.

An aspect of this disclosure provides a game control method, performed by a computer device, the method including: displaying a first game picture, the first game picture including a picture corresponding to a first field-of-view range, and the first field-of-view range being a field-of-view range of a virtual object in a virtual environment; and displaying a second game picture in response to a trigger operation on the first game picture, the second game picture including the first game picture and a target field-of-view picture, the target field-of-view picture being determined based on a second field-of-view range and the virtual environment, the second field-of-view range being determined based on pose information of the virtual object, and the second field-of-view range being different from the first field-of-view range.

An aspect of this disclosure provides a game control apparatus, including: a first display module, configured to display a first game picture, the first game picture including a picture corresponding to a first field-of-view range, and the first field-of-view range being a field-of-view range of a virtual object in a virtual environment; and a second display module, configured to display a second game picture in response to a trigger operation on the first game picture, the second game picture including the first game picture and a target field-of-view picture, the target field-of-view picture being determined based on a second field-of-view range and the virtual environment, the second field-of-view range being determined based on pose information of the virtual object, and the second field-of-view range being different from the first field-of-view range.

An aspect of this disclosure provides a computer device, including a processor and a memory, the memory having computer-executable instructions or a computer program stored therein, and the computer-executable instructions or the computer program being loaded and executed by the processor, to enable the computer device to implement the game control methods in aspects of this disclosure.

An aspect of this disclosure provides a non-transitory computer-readable storage medium storing instructions which, when executed by a processor, cause the processor to implement the game control methods in aspects of this disclosure.

An aspect of this disclosure provides a computer program or a computer program product, including computer-executable instructions or a computer program, the computer-executable instructions or the computer program, when executed by a processor, implementing the game control methods in aspects of this disclosure.

The technical solutions provided in aspects of this disclosure at least achieve the following beneficial effects.

In the technical solutions provided in aspects of this disclosure, a second game picture is displayed, the second game picture includes a target field-of-view picture corresponding to a second field-of-view range and a first game picture corresponding to a first field-of-view range, and the second field-of-view range is different from the first field-of-view range, to enrich types of field-of-view ranges for a user to observe a virtual scene on a human-computer interaction interface. The displayed field-of-view range is expanded, so that a player can better obtain information about a virtual environment around a virtual object, thereby increasing scalability and interactivity of the field-of-view range. A game player uses the expanded and displayed field-of-view range to make an in-game decision promptly based on the information about the virtual environment, thereby improving human-computer interaction efficiency, and further improving game experience of the player.

### BRIEF DESCRIPTION OF THE DRAWINGS

FIG. 1A is a schematic diagram of a first implementation environment of a game control method according to an aspect of this disclosure.

FIG. 1B is a schematic diagram of a second implementation environment of a game control method according to an aspect of this disclosure.

FIG. 2 is a flowchart of a game control method according to an aspect of this disclosure.

FIG. 3 is a schematic diagram of a first game picture according to an aspect of this disclosure.

FIG. 4 is a flowchart of generating a second game picture according to an aspect of this disclosure.

FIG. 5 is a schematic diagram of a second game picture according to an aspect of this disclosure.

FIG. 6 is a schematic diagram of a second game picture after a target field-of-view picture is moved according to an aspect of this disclosure.

FIG. 7 is a schematic diagram of a second game picture after a target field-of-view picture is zoomed in according to an aspect of this disclosure.

FIG. 8 is a schematic diagram of an interaction process between an application program and a server according to an aspect of this disclosure.

FIG. 9 is a schematic diagram of a structure of a game control apparatus according to an aspect of this disclosure.

FIG. 10 is a schematic diagram of a structure of a terminal device according to an aspect of this disclosure.

FIG. 11 is a schematic diagram of a structure of a server according to an aspect of this disclosure.

FIG. 12 is a schematic diagram of switching display areas of a target field-of-view picture and a first game picture according to an aspect of this disclosure.

FIG. 13 is a schematic diagram of adjusting transparency of a target field-of-view picture according to an aspect of this disclosure.

### DETAILED DESCRIPTION

To make objectives, technical solutions, and advantages of this disclosure clearer, the following describes this disclosure in further detail with reference to the accompanying drawings. The described aspects are not to be considered as a limitation to this disclosure. Other aspects shall fall within the scope of this disclosure. Further, the descriptions of the terms are provided as examples and are not intended to limit the scope of the disclosure.

Terms such as “first” and “second” in this disclosure are intended to distinguish between similar objects but do not necessarily indicate a specific order or sequence. The terms used in such a way are interchangeable under appropriate conditions, so that aspects of this disclosure described herein can be implemented in an order other than that illustrated or described herein. The implementations described in the following aspects do not represent all implementations consistent with this disclosure. On the contrary, the implementations are merely examples of apparatuses and methods that are described in detail in the appended claims and that are consistent with some aspects of this disclosure.

Before the technical solutions in this disclosure are described, abbreviations and key terms described in aspects of this disclosure are first defined.

A virtual environment is an environment provided (or displayed) by an application program when running on a terminal device. The virtual environment is an environment created for a virtual object to carry out an activity. The virtual environment may be a two-dimensional virtual environment, a two-and-a-half-dimensional virtual environment, a three-dimensional virtual environment, or the like. The virtual environment may be a simulated environment or a semi-simulated environment of the real world, or a fictional environment. For example, a virtual environment in aspects of this disclosure is a three-dimensional virtual environment.

A virtual object is a movable object in a virtual environment. The movable object may be a virtual character, a virtual animal, a cartoon character, or the like. A player can manipulate the virtual object by using a peripheral component or by tapping a touch display screen. Each virtual object has a shape and a volume in the virtual environment, and occupies a part of space in the virtual environment. For example, when the virtual environment is a three-dimensional virtual environment, the virtual object is a three-dimensional model created based on a skeletal animation technology.

A third-person perspective is a perspective in which an in-game virtual camera is positioned at a specific distance behind a virtual object controlled by a player, and the virtual object controlled by the player and all elements in a specific surrounding environment may be seen in a virtual environment.

A first-person perspective means that a game is experienced from a subjective perspective of a player.

A computer vision (CV) technology is a field of science that studies how to use a machine to “see”, and that uses a camera and a computer to replace human eyes to perform machine vision, such as recognition and measurement on a target, and further perform graphic processing, so that the computer processes the target into an image more suitable for human eyes to observe, or an image transmitted to an instrument for detection. As a scientific discipline, the computer vision studies related theories and technologies, and attempts to establish an artificial intelligence system that can obtain information from images or multidimensional data. Large-scale model technologies bring an important change to the development of the computer vision technology. Pretrained models in the vision field, for example, a swin transformer, a vision transformer (ViT), a vision MOE (V-MOE), and a masked autoencoder (MAE), can be rapidly and widely applicable to a specific downstream task through fine-tuning. The computer vision technologies include technologies such as image processing, image recognition, image semantic understanding, image retrieval, optical character recognition (OCR), video processing, video semantic understanding, video content/behavior recognition, three-dimensional object reconstruction, a three-dimensional (3D) technology, virtual reality, augmented reality, simultaneous localization and mapping, and further include common biometric recognition technologies such as face recognition and fingerprint recognition.

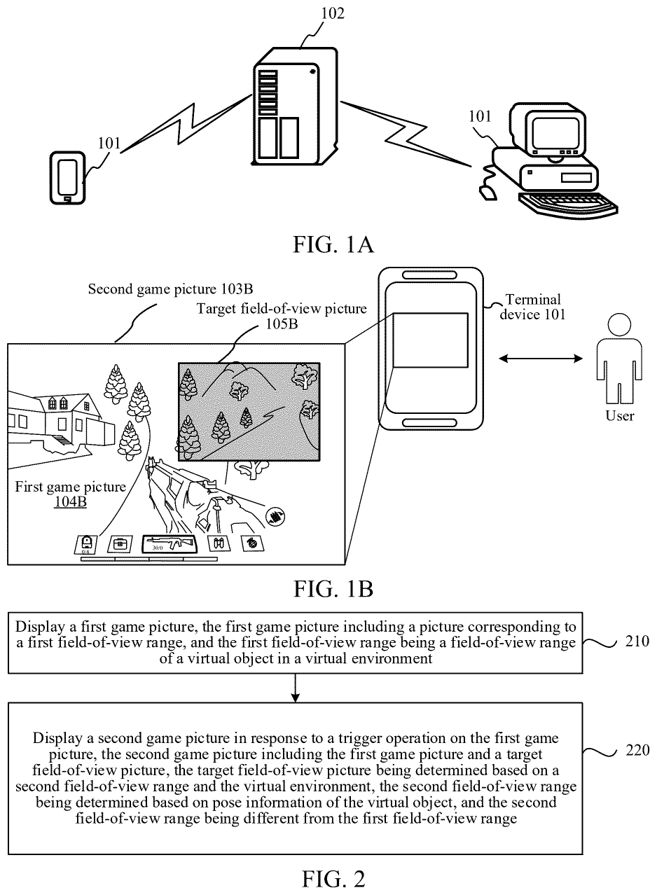

Before FIG. 1A is described, game modes in a solution cooperatively implemented by a terminal device and a server are first described. The solution cooperatively implemented by the terminal device and the server mainly has two game modes, namely, a local game mode and a cloud game mode. The local game mode means that the terminal device and the server cooperatively run game logic processing. Some operation instructions input by a player into the terminal device are used by the terminal device to run game logic processing, and some other operation instructions are used by the server to run game logic processing. In addition, game logic processing run by the server is usually more complex and needs to consume more computing power. The cloud game mode means that game logic processing is run by the server, and game scene data is rendered into audio and video streams by a cloud server, and the audio and video streams are transmitted to the terminal device via a network for display. The terminal device only needs to have a basic streaming media playback capability and a capability of obtaining operation instructions of the player and transmitting the operation instructions of the player to the server.

FIG. 1A is a schematic diagram of a first implementation environment of a game control method according to an aspect of this disclosure. As shown in FIG. 1A, the implementation environment includes a terminal device 101 and a server 102.

A client that can provide a virtual environment is installed and running on the terminal device 101. The terminal device 101 is configured to perform the game control method provided in this aspect of this disclosure. The terminal device 101 displays a virtual object and a virtual environment including the virtual object, and applicable to an application mode that depends on a computing capability of the server 102 to complete virtual scene calculation and outputs a virtual scene by using the terminal device 101.

For example, the client may be a game client. The game client that provides a virtual environment in the terminal device 101 may be a third-person shooting (TPS) game, a first-person shooting (FPS) game, a multiplayer online battle arena (MOBA) game, a multiplayer shooting survival game, a massive multiplayer online role-playing game (MMO), an action role playing game (ARPG), a virtual reality (VR) client, an augmented reality (AR) client, a three-dimensional map program, a map simulation program, a social client, an interactive entertainment client, or the like.

The server 102 is configured to provide a background service for the game client that can provide the virtual environment and that is installed in the terminal device 101. In some aspects, the server 102 takes on primary computing work, and the terminal device 101 takes on secondary computing work. Alternatively, the server 102 takes on secondary computing work, and the terminal 101 takes on primary computing work. Alternatively, a distributed computing architecture is used between the terminal device 101 and the server 102 for collaborative computing.

In some aspects, the terminal device 101 may be any electronic device product that can perform human-computer interaction with a user in one or more manners, such as through a keyboard, a touchpad, a touchscreen, a remote control, voice interaction, or a handwriting device. For example, the terminal device 101 may be a smartphone, a tablet computer, a notebook computer, a desktop computer, a smart speaker, a smart watch, a personal computer (PC), a mobile phone, a personal digital assistant (PDA), a wearable device, a pocket PC (PPC), a smart on-board unit, or a smart television.

The terminal device 101 may be one of a plurality of terminal devices. This aspect only uses the terminal device 101 as an example for description. It is noted that there may be more or fewer terminal devices 101. For example, the foregoing terminal device 101 may be only one, or the foregoing terminal device 101 may be tens or hundreds, or more. A quantity and a device type of the terminal device 101 are not limited in this aspect of this disclosure.

The server 102 may be one server, a server cluster formed by a plurality of servers, or any one of a cloud computing center or a virtualization center. This is not limited in this aspect of this disclosure. The server 102 is in direct or indirect communication connection with the terminal device 101 in a wired or wireless communication manner. The server 102 has a data receiving function, a data processing function, and a data transmitting function. The server 102 may alternatively have other functions, which are not limited in this aspect of this disclosure.

Using an example in which visual perception of a virtual scene is formed, the server 102 calculates display data (for example, scene data) related to the virtual scene and transmits the display data to the terminal device 101 via a network. The terminal device 101 relies on graphics computing hardware to complete loading, parsing, and rendering for calculating the display data, and relies on graphics output hardware to output the virtual scene to form visual perception. For example, a two-dimensional video frame may be presented on a display screen of a smartphone, or a video frame for achieving a three-dimensional effect may be projected on lenses of augmented reality/virtual reality glasses. For perception in the form of the virtual scene, the virtual scene may be outputted through corresponding hardware of the terminal device 101, for example, auditory perception is formed by using a microphone, and tactile perception is formed by using a vibrator.

For example, the terminal device 101 runs a client (for example, a web-based game application), and outputs a virtual scene including role-playing during running of the client. The virtual scene may be an environment for game characters to interact, for example, a plain, a street, or a valley for the game characters to fight against each other. A first virtual object may be a game character controlled by a user, in other words, the first virtual object is controlled by a real user, and moves in the virtual scene in response to an operation by the real user on a controller (for example, a touch screen, a voice operated switch, a keyboard, a mouse, or a joystick). For example, when the real user moves the joystick to the right, the first virtual object may move to the right in the virtual scene, stay still, or jump, or the first virtual object may be controlled to perform an operation such as shooting.

For example, when a user plays a game on the terminal device 101, a virtual object and a virtual scene are displayed on a human-computer interaction interface of the terminal device 101. The server 102 generates data of a corresponding second game picture by using the game control method provided in this aspect of this disclosure. The second game picture includes a first game picture and a target field-of-view picture. A second field-of-view range corresponding to the target field-of-view picture is different from a first field-of-view range of the virtual object. The server 102 sends data of a game picture to the terminal device 101 via a network, so that the user can observe a broader game picture, thereby improving game experience of the user.

It is noted that the terminal device 101 and the server 102 are merely examples for description, and that other existing or future possible terminal devices or servers, if applicable to this disclosure, may also fall within the scope of this disclosure and are incorporated herein by reference.

FIG. 1B is a schematic diagram of a second implementation environment of a game control method according to an aspect of this disclosure, which is applicable to some application modes in which calculation of relevant data of a virtual scene is implemented depending on a graphics processing hardware computing capability of a terminal device 101, for example, a standalone/offline game completes output of the virtual scene through various types of terminal devices 101 such as a smartphone, a tablet computer, and a virtual reality/augmented reality device.

For example, a type of the graphics processing hardware includes a central processing unit (CPU) and a graphics processing unit (GPU).

When visual perception of the virtual scene is formed, the terminal device 101 calculates, through graphics computing hardware, data required for display, and completes loading, parsing, and rendering of the display data. The graphics computing hardware outputs a video frame capable of forming the visual perception of the virtual scene. For example, a two-dimensional video frame is presented on a display screen of a smartphone, or a video frame for achieving a three-dimensional display effect is projected on lenses of augmented reality/virtual reality glasses. In addition, to enrich a perception effect, the terminal device 101 may also form one or more of auditory perception, tactile perception, motion perception, and taste perception through different hardware.

For example, the terminal device 101 runs a client (for example, a standalone game application), and outputs a virtual scene including role-playing during running of the client. The virtual scene may be an environment for game characters to interact, for example, a plain, a street, or a valley for the game characters to fight against each other. A first virtual object may be a game character controlled by a user, in other words, the first virtual object is controlled by a real user, and moves in the virtual scene in response to an operation by the real user on a controller (for example, a touch screen, a voice operated switch, a keyboard, a mouse, or a joystick). For example, when the real user moves the joystick to the right, the first virtual object may move to the right in the virtual scene, stay still, or jump, or the first virtual object may be controlled to perform an operation such as shooting. A second game picture 103B is displayed on a human-computer interaction interface of the terminal device 101, and the second game picture 103B includes a first game picture 104B and a target field-of-view picture 105B.

An aspect of this disclosure provides a game control method. The method may be applied to the foregoing implementation environment shown in FIG. 1A or FIG. 1B. A flowchart of a game control method according to an aspect of this disclosure shown in FIG. 2 is used as an example. The method may be performed independently by the terminal device 101 in FIG. 1B, or may be performed by the terminal device 101 and the server 102 (for example, in FIG. 1A) through interaction. For example, the method is performed by the terminal device 101. As shown in FIG. 2, the method includes the following operation 210 and operation 220.

Operation 210: Display a first game picture, the first game picture including a picture corresponding to a first field-of-view range, and the first field-of-view range being a field-of-view range of a virtual object in a virtual environment. For example, a first virtual scene of a virtual environment is output for display according to a first field-of-view of a virtual character located in the virtual environment.

In an aspect of this disclosure, a game client that can provide the virtual environment is installed and run in a terminal device. The game client may be a client of any game. This is not limited in this aspect of this disclosure. For example, the client in this aspect of this disclosure is a game application program. In response to that the application program receives a start instruction, the terminal device displays a game preloading interface of the application program. The game preloading interface may include a team formation interface, a game matching interface, a current game loading interface, and the like.

For example, the virtual environment is an environment provided by the application program in the terminal device. In the virtual environment, a plurality of virtual objects may be displayed, and different virtual objects may be controlled by different players. In addition to displaying the virtual object, an environmental element may be further displayed in the virtual environment. The environmental element may include a mountain, a plain, a river, a lake, an ocean, a desert, a swamp, quicksand, sky, a plant, a building, and the like. The environmental element may further include a virtual item, a vehicle, and the like. This disclosure uses the virtual environment for description as an example. This is not limited in this disclosure.

In an aspect of this disclosure, after a game starts, the application program in the terminal device may display the first game picture. The first game picture includes the picture corresponding to the first field-of-view range. The first field-of-view range is a field-of-view range of the virtual object in the virtual environment, that is, a picture acquired by observing the virtual environment from a perspective of the virtual object. The perspective of the virtual object may be a first-person perspective of the virtual object, a third-person perspective of the virtual object, or the like. This is not limited in this aspect of this disclosure.

For example, the perspective of the virtual object may be determined based on the virtual environment acquired by a virtual camera. When the first-person perspective is used, the virtual camera may be located around the eyes of the virtual object or at the eyes of the virtual object. When the third-person perspective is used, the virtual camera may be located behind the virtual object and bound to the virtual object, or may be located at any position at a reference distance from the virtual object. Through the virtual camera, the virtual object in the virtual environment may be observed from different perspectives. The reference distance is set based on experience or flexibly adjusted based on the virtual environment. For example, in addition to the first-person perspective and the third-person perspective, another perspective is also included, for example, a top-view perspective. When the top-view perspective is used, the virtual camera may be above the head of the virtual object, and the top-view perspective is a perspective for observing the virtual environment from an aerial angle. The virtual camera is only configured to represent pictures in the virtual environment that can be observed by the virtual object from different perspectives, and the virtual camera is not actually displayed in a game picture.

In this disclosure, the first-person perspective of the virtual object is used as an example for description. For example, the first game picture is a picture displayed from the first-person perspective, and a virtual camera corresponding to the first-person perspective is a second virtual camera.

For example, initial pose information of the virtual object and parameter information of the second virtual camera are obtained, the initial pose information including at least one of initial position information, initial orientation information, or initial posture information of the virtual object in the virtual environment, and the second virtual camera being configured to generate the picture corresponding to the first field-of-view range. The first field-of-view range of the virtual object in the virtual environment is determined based on the initial pose information and the parameter information of the second virtual camera. The first game picture is displayed based on the first field-of-view range.

The parameter information of the second virtual camera may include an intrinsic parameter of the second virtual camera, and the intrinsic parameter of the second virtual camera may include, but is not limited to, a focal length, coordinates of a principal point, a distortion coefficient, and the like. The first game picture is a picture generated by the second virtual camera that automatically follows the virtual object, and the second virtual camera is configured to simulate the first-person perspective of the virtual object. When a position of the virtual object in the virtual environment changes, a position of the second virtual camera changes as the position of the virtual object in the virtual environment changes, but a relative position between the second virtual camera and the virtual object remains unchanged. Therefore, external parameter information of the second virtual camera may be determined based on the initial pose information of the virtual object, where the external parameter information of the second virtual camera may include, but is not limited to, a position and an orientation of the second virtual camera.

After the initial pose information of the virtual object and the parameter information of the second virtual camera are obtained, the first field-of-view range of the first virtual object may be further determined in the virtual environment based on the initial pose information and the parameter information of the second virtual camera. The first field-of-view range is a field-of-view range of the virtual object in the virtual environment, and may be represented by a field-of-view range that can be acquired by the second virtual camera.

After the first field-of-view range of the virtual object is obtained, the picture corresponding to the first field-of-view range may be determined in the virtual environment based on the first field-of-view range of the virtual object. For example, a picture acquired by the second virtual camera in the virtual environment may be obtained based on the intrinsic parameter of the second virtual camera. The first game picture is obtained by rendering the picture acquired by the second virtual camera.

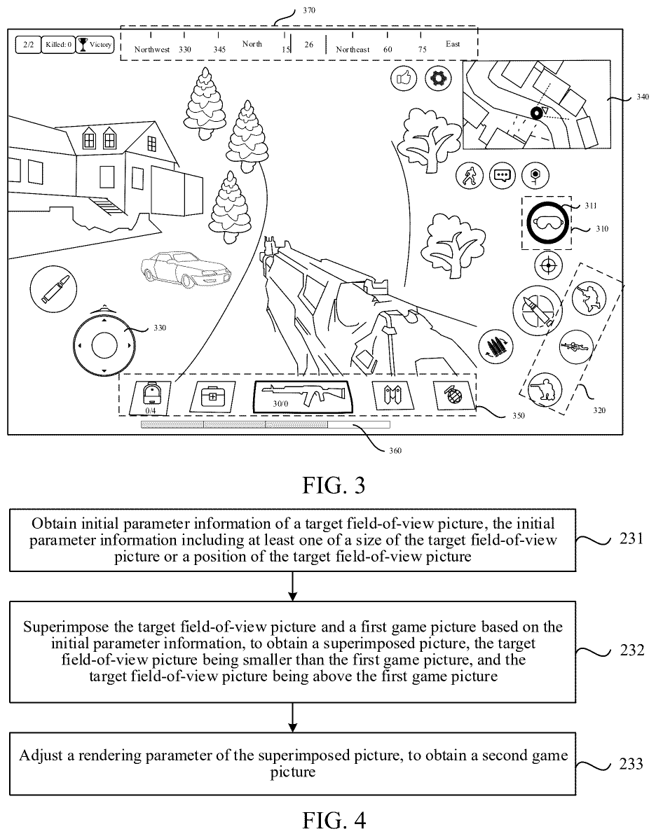

FIG. 3 is a schematic diagram of a first game picture according to an aspect of this disclosure. As shown in FIG. 3, the first game picture may include a field-of-view control 310, a pose control 320, a virtual joystick control 330, a global map 340, a virtual item 350, a virtual health point 360, and a direction information display unit 370.

The field-of-view control 310 may display a state of the current field-of-view control. The field-of-view control displays energy 311 of the virtual object. For example, the field-of-view control 310 is in a triggerable state, the energy 311 of the virtual object fills an entire circle, and the circle may represent an energy threshold when the field-of-view control is in the triggerable state. When the field-of-view control 310 is in a non-triggered state (not shown in the figure), the energy 311 of the virtual object does not fill the entire circle. The energy 311 of the virtual object dynamically varies over time as time of the virtual object in the virtual environment increases, and gradually fills the entire circle.

For example, the energy of the virtual object is a resource in a virtual game, and the energy of the virtual object is adjusted and allocated in real time based on a behavior of the virtual object and a game progress. For example, an energy value of the virtual object gradually increases as game duration increases, or the energy value is consumed when the virtual object performs an operation.

The pose control 320 and the virtual joystick control 330 are configured to control a position and a posture of the virtual object in the virtual environment. The virtual joystick control 330 may control the virtual object to move back and forth and left and right in the virtual environment. The pose control 320 may control the posture of the virtual object, for example, a running posture, a crouching posture, and a lying-down posture. The position of the virtual object in the virtual environment may be obtained by observing the global map 340, and the direction information display unit 370 may display a current perspective direction of the virtual object. The current perspective direction of the virtual object may be a direction of a center of the first field-of-view range. By rotating a screen of the terminal device, the perspective direction of the virtual object may be changed, so that information about the virtual environment around the virtual object may be obtained.

The virtual object interacts with the virtual environment or a virtual object controlled by another player by using the virtual item 350. The virtual object may obtain the virtual item 350 while moving in the virtual environment. The virtual item 350 may include a plurality of virtual items, and different virtual items may have different functions. A virtual item for expanding a field-of-view range may be displayed in the virtual item 350, or may not be displayed in the virtual item 350, and the virtual object may directly use the virtual item for expanding the field-of-view range. The virtual health point 360 of the virtual object may be further displayed in the first game picture, and the virtual health point 360 may represent a life status of the virtual object.

This disclosure describes content included in the first game picture as an example, and the first game picture may be set based on an actual requirement. This is not limited in this disclosure.

Operation 220: Display a second game picture in response to a trigger operation on the first game picture, a target field-of-view picture being determined based on a second field-of-view range and the virtual environment, the second field-of-view range being determined based on pose information of the virtual object, and the second field-of-view range being different from the first field-of-view range. For example, it is determined that a trigger operation is performed to display a plurality of fields-of-view of the virtual character. Based on the trigger operation, a second virtual scene of the virtual environment is output for display according to a second field-of-view of the virtual character concurrently with the first virtual scene. The second field-of-view is different from the first field-of-view.

In an aspect of this disclosure, before trigger information for expanding the field-of-view range is received, a trigger operation on the field-of-view control may be further detected. In response to that the trigger operation on the field-of-view control is detected, the trigger information for expanding the field-of-view range is obtained. The field-of-view control is in the first game picture. In some aspects, before the trigger operation on the field-of-view control is detected, a state of the field-of-view control may be further detected. The state of the field-of-view control includes a triggerable state and a non-triggered state. When the field-of-view control is in the triggerable state, the field-of-view control may receive the trigger operation and generate corresponding trigger information after receiving the trigger operation. When the field-of-view control is in the non-triggered state, the field-of-view control does not receive the trigger operation, or the field-of-view control does not generate corresponding trigger information even after receiving the trigger operation.

For example, the state of the field-of-view control may be determined by energy of the virtual object. For example, current energy of the virtual object is detected. The current energy of the virtual object is compared with an energy threshold, where the energy threshold indicates energy needed by the field-of-view control to be in the triggerable state, and in response to that the energy of the virtual object is not less than the energy threshold, the field-of-view control is in the triggerable state; or in response to that the energy of the virtual object is less than the energy threshold, the field-of-view control is in the non-triggered state.

In some aspects, the energy of the virtual object may be proportional to game time. For example, the energy of the virtual object increases as game time of a player increases. When the game time reaches a time threshold, namely, the energy threshold, the field-of-view control is in the triggerable state. For example, the energy threshold of the field-of-view control is configured to be three minutes. The energy of the virtual object increases as time of the virtual object in the virtual environment increases. When the energy of the virtual object is not less than three minutes, the field-of-view control is in the triggerable state. The field-of-view control in the triggerable state is configured to receive the trigger operation, and the trigger operation may include but is not limited to a click/tap operation.

For example, the state of the field-of-view control may be determined based on a first state of the virtual object. For example, the first state of the virtual object is detected, where the first state is a state of the virtual object in the virtual environment at a current moment. In response to that the first state of the virtual object meets an abnormal triggered state, the field-of-view control is in the non-triggered state. When the field-of-view control is in the non-triggered state, even if the trigger operation is received, corresponding trigger information is not generated. The abnormal triggered state includes at least one of a knocked-down state, a vehicle-using state, a climbing state, or an awaiting rescue state. This disclosure describes content of the abnormal triggered state as an example, and the abnormal triggered state may be set based on an actual situation. This is not limited in this disclosure.

For example, the knocked-down state is a state in which the virtual object is attacked by another virtual object or an obstacle and falls to the ground and is unable to get up. When the virtual object is in the knocked-down state, the target field-of-view picture is not displayed. The vehicle-using state is at least one of the following states related to a vehicle: The virtual object is in the vehicle (for example, sitting in a front passenger position of a car), the virtual object is driving the vehicle (for example, driving a motorcycle or riding a bicycle), the virtual object is located inside the vehicle (for example, in a plane or a ship), or the virtual object is above the vehicle (for example, riding a horse). The awaiting rescue state is a state of waiting, after a health value of a first virtual object drops to zero, for another virtual object to perform a rescue. The virtual object enters the awaiting rescue state from a moment when the health value drops to zero, and when preconfigured duration is reached, the awaiting rescue state ends, and the virtual object dies. In the climbing state, terrain on which the virtual object performs a climbing action may be flat ground, a slope, a cliff, or a wall.

In an aspect of this disclosure, after the state of the field-of-view control is detected, in response to that the field-of-view control is in the triggerable state, the trigger operation on the field-of-view control is detected. For example, the state of the field-of-view control is detected. When the field-of-view control is in the triggerable state, whether the field-of-view control receives the trigger operation is detected. In response to that the field-of-view control receives the trigger operation and a use operation of the virtual item, the trigger information for expanding the field-of-view range is obtained. For example, when it is detected that the field-of-view control receives the trigger operation, the virtual item is generated, and when the use operation of the virtual item is received, the trigger information for expanding the field-of-view range is generated.

In an aspect of this disclosure, in response to that the trigger information for expanding the field-of-view range is received, the second field-of-view range is determined based on the pose information of the virtual object. For example, a field-of-view direction and position information of a first virtual camera are determined based on the pose information of the virtual object. The field-of-view direction is a direction corresponding to the second field-of-view range. For example, the field-of-view direction may be a direction corresponding to a center line of the second field-of-view range. The pose information of the virtual object may include an orientation of the virtual object, and an angle between the field-of-view direction and the orientation of the virtual object is a reference angle.

For example, the pose information of the virtual object may include at least one of position information, orientation information, or posture information of the virtual object. The orientation of the virtual object is determined based on the orientation information of the virtual object. With reference to FIG. 3, the orientation of the virtual object may be obtained by using the direction information display unit 370. The field-of-view direction is determined based on the orientation of the virtual object, and the angle between the field-of-view direction and the orientation of the virtual object is the reference angle. There may be one or more field-of-view directions, each field-of-view direction corresponds to one reference angle, and the reference angle may be a positive value or a negative value. When the reference angle is a positive value, the orientation of the virtual object is rotated clockwise by the reference angle, to obtain the field-of-view direction. When the reference angle is a negative value, the orientation of the virtual object is rotated anticlockwise by the reference angle, to obtain the field-of-view direction. A value of the reference angle may be set based on an actual situation.

In an aspect of this disclosure, a quantity of the field-of-view directions and the value of the reference angle are fixed values. In this disclosure, an example in which there are two field-of-view directions is used for description. For example, the reference angle is set to ±135°, that is, the angle between the field-of-view direction and the orientation of the virtual object is 135°. In this case, the field-of-view direction is a left rear direction and a right rear direction of the virtual object.

In another aspect of this disclosure, on a game setting interface, the player may set the value of the reference angle and the quantity of the reference angles based on a habit of the player. A corresponding field-of-view direction may be obtained based on the value of the reference angle and the quantity of the reference angles that are set by the player.

Because the field-of-view direction is different from the orientation of the virtual object, in a subsequent process, the second field-of-view range determined based on the field-of-view direction is different from the first field-of-view range. The first field-of-view range may partially overlap the second field-of-view range, or the second field-of-view range may not overlap the first field-of-view range at all.

In an aspect of this disclosure, the first virtual camera may be fixed at a reference position of the virtual object, for example, fixed at or around the head of the virtual object. Position information of the first virtual camera may be determined based on the position information and the posture information of the virtual object, and an orientation of the first virtual camera may be the field-of-view direction. The first virtual camera moves with movement of the virtual object, in other words, a relative position between the first virtual camera and the virtual object remains unchanged.

In an aspect of this disclosure, after the position information of the first virtual camera is determined, parameter information of the first virtual camera may be further obtained, and the second field-of-view range is determined based on the parameter information and the position information of the first virtual camera and the field-of-view direction.

For example, the parameter information of the first virtual camera may include, but is not limited to, a focal length, coordinates of a principal point, a distortion coefficient, and the like. A position and an orientation of the first virtual camera are determined based on the position information of the first virtual camera and the field-of-view direction. The second field-of-view range may be determined in the virtual environment by using the parameter information of the first virtual camera. A quantity of first virtual cameras may be determined based on the quantity of the field-of-view directions, and each field-of-view direction may correspond to one first virtual camera.

In an aspect of this disclosure, after the second field-of-view range is determined, a picture of the first virtual camera may be further rendered based on the second field-of-view range and the virtual environment, to obtain the target field-of-view picture.

For example, a to-be-rendered picture of the first virtual camera may be obtained based on the second field-of-view range, a rendering parameter is obtained by using related information of the virtual environment, and the picture of the first virtual camera is rendered by using the rendering parameter, to obtain the target field-of-view picture. After the target field-of-view picture is obtained, the target field-of-view picture may be stored into a render target.

In an aspect of this disclosure, before the second game picture is displayed, the second game picture may be further generated. FIG. 4 is a flowchart of generating a second game picture according to an aspect of this disclosure. As shown in FIG. 4, generating the second game picture may include operation 231 to operation 233.

Operation 231: Obtain initial parameter information of a target field-of-view picture, the initial parameter information including at least one of a size of the target field-of-view picture or a position of the target field-of-view picture.

For example, the target field-of-view picture may be a rectangular picture. A length and a width of the rectangular picture are obtained, and the size of the target field-of-view picture is determined. The target field-of-view picture is smaller than a first game picture.

Operation 232: Superimpose the target field-of-view picture and the first game picture based on the initial parameter information, to obtain a superimposed picture, the target field-of-view picture being smaller than the first game picture, and the target field-of-view picture being above the first game picture. For example, the second virtual scene is output for display as an overlay over a portion of the first virtual scene. A display size of the second virtual scene is smaller than a display size of the first virtual scene.

For example, the target field-of-view picture in a render target is adjusted based on parameter information of the target field-of-view picture, and the adjusted target field-of-view picture is superimposed on the first game picture based on position information of the target field-of-view picture. Because the target field-of-view picture is smaller than the first game picture, when picture superimposition is performed, the target field-of-view picture is above the first game picture.

Operation 233: Adjust a rendering parameter of the superimposed picture, to obtain the second game picture.

Adjusting the rendering parameter may include but is not limited to fading the superimposed picture. For example, the second game picture is obtained by adjusting transparency of the target field-of-view picture.

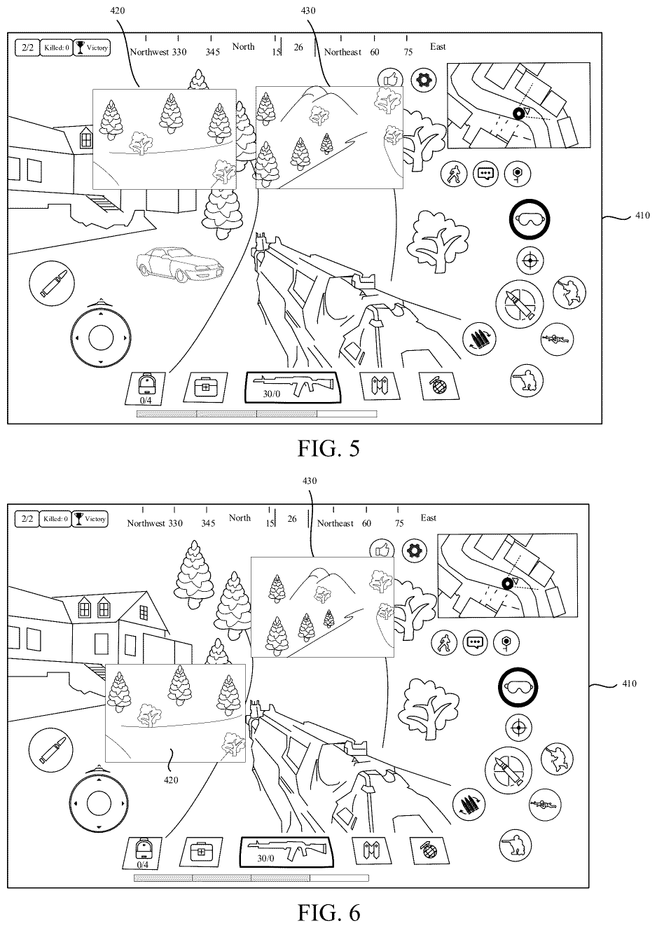

In an aspect of this disclosure, after the second game picture is obtained, the second game picture may be displayed. In this disclosure, two target field-of-view pictures are used as an example. FIG. 5 is a schematic diagram of a second game picture according to an aspect of this disclosure. As shown in FIG. 5, the second game picture may include a first game picture 410, a first target field-of-view picture 420, and a second target field-of-view picture 430. The first game picture 410 is a picture corresponding to a first field-of-view range of a virtual object at a current moment, and the first target field-of-view picture 420 and the second target field-of-view picture 430 are pictures corresponding to a second field-of-view range of the virtual object at the current moment. For example, the first target field-of-view picture 420 may display a field-of-view picture to the left rear of the virtual object, and the second target field-of-view picture 430 may display a field-of-view picture to the right rear of the virtual object. When the virtual object moves, the first game picture 410, the first target field-of-view picture 420, and the second target field-of-view picture 430 also change accordingly.

During a game, a player not only can obtain the first game picture in a forward direction of the virtual object through the second game picture, but also can obtain the target field-of-view picture in another direction of the virtual object, and can better obtain information around the virtual object through the second game picture. Through the second game picture, the player can quickly switch a battle mode, attack another virtual object, or evade an attack from another virtual object.

In this disclosure, the first game picture corresponding to the first field-of-view range is superimposed on the target field-of-view picture corresponding to the second field-of-view range, to obtain the second game picture. During the game, a field of view of the player is expanded, and awareness of the player of the virtual environment around the virtual object is enhanced, so that the player can observe the virtual environment around the virtual object without rotating a screen, thereby improving game experience of the player.

In an aspect of this disclosure, after the second game picture is obtained, control information of the target field-of-view picture in the second game picture may be further detected. The control information includes at least one of position movement information, picture zoom-in information, or picture zoom-out information. In response to that the control information is detected, a corresponding operation on the target field-of-view picture is controlled based on the control information. The control information may be generated based on trigger information of the target field-of-view picture. When the second game picture has a plurality of target field-of-view pictures, the plurality of target field-of-view pictures may be controlled based on the control information, or a selected target field-of-view picture may be controlled based on the control information.

For example, a trigger operation on the position movement information may be touching and holding the target field-of-view picture, a trigger operation on the picture zoom-in information may be double-clicking/tapping the target field-of-view picture or performing two-finger press on the target field-of-view picture and moving the fingers outward from the target field-of-view picture, and a trigger operation on the picture zoom-out information may be single-clicking/tapping the target field-of-view picture or performing two-finger press on the target field-of-view picture and moving the fingers inward from the target field-of-view picture. Corresponding trigger information may be generated when the trigger operation on the target field-of-view picture is detected, and the control information of the target field-of-view picture is generated based on the trigger information.

In some aspects, when the control information is the position movement information, movement information of a pressed position in the target field-of-view picture may be detected, corresponding control information is generated based on the movement information of the pressed position, and the target field-of-view picture is controlled, based on the control information, to move according to the movement information of the pressed position. FIG. 6 is a schematic diagram of a second game picture after a target field-of-view picture is moved according to an aspect of this disclosure. With reference to FIG. 5 and FIG. 6, after the first target field-of-view picture 420 and the second target field-of-view picture 430 receive different position movement information, the first target field-of-view picture 420 and the second target field-of-view picture 430 may be controlled to move based on the position movement information.

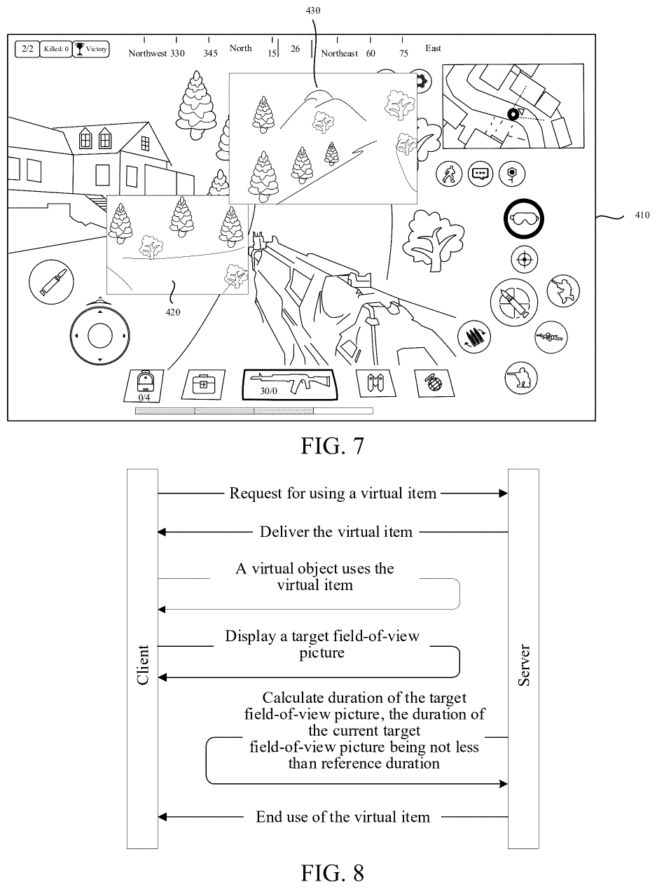

For example, when the control information is the picture zoom-in information, the trigger operation on the target field-of-view picture may be detected. When the trigger operation is double-clicking/tapping the target field-of-view picture, corresponding control information of the target field-of-view picture is generated based on a reference zoom-in ratio. The reference zoom-in ratio may be set based on an actual situation, or may be a reference zoom-in ratio preset by an application program. When the trigger operation is performing two-finger press and moving the fingers outward from the target field-of-view picture, a zoom-in ratio may be determined based on a movement distance between two pressed points, and corresponding control information is generated based on the zoom-in ratio. After the corresponding control information is obtained, the target field-of-view picture is zoomed in based on the control information. FIG. 7 is a schematic diagram of a second game picture after a target field-of-view picture is zoomed in according to an aspect of this disclosure. As shown in FIG. 7, the second target field-of-view picture 430 receives control information for zooming in a picture. The control information includes a zoom-in ratio. A picture zoom-in operation is performed on the second target field-of-view picture 430 based on the zoom-in ratio in the control information.

That the control information is the picture zoom-out information is similar to that the control information is the picture zoom-in information. Details are not described herein again.

During the game, the player may adjust the size and the position of the target field-of-view picture, and may move the target field-of-view picture to a specified position, zoom in or zoom out the target field-of-view picture. This may reduce, to some extent, obstruction of effective information of the virtual environment in the first game picture by the target field-of-view picture, so that the player can better observe the target field-of-view picture and the first game picture, and improve a degree of control of the player over the virtual environment around the virtual object.

In some aspects, after the second game picture is displayed, display areas of the target field-of-view picture and the first game picture are exchanged in response to a switch operation on the target field-of-view picture in the second game picture, or in response to a switch operation on the first game picture in the second game picture, to form a fourth game picture. The fourth game picture includes the superimposed picture of the first game picture and the target field-of-view picture, the first game picture is smaller than the target field-of-view picture, and the first game picture is above the target field-of-view picture.

For example, the switch operation may be any one of the following operations: a drag operation, a double-click/tap operation, and a touch and hold operation. Exchanging the display areas of the target field-of-view picture and the first game picture may be implemented as follows: determining a first display area of the first game picture and a second display area of the target field-of-view picture, displaying the target field-of-view picture in the first display area, and displaying the first game picture in the second display area.

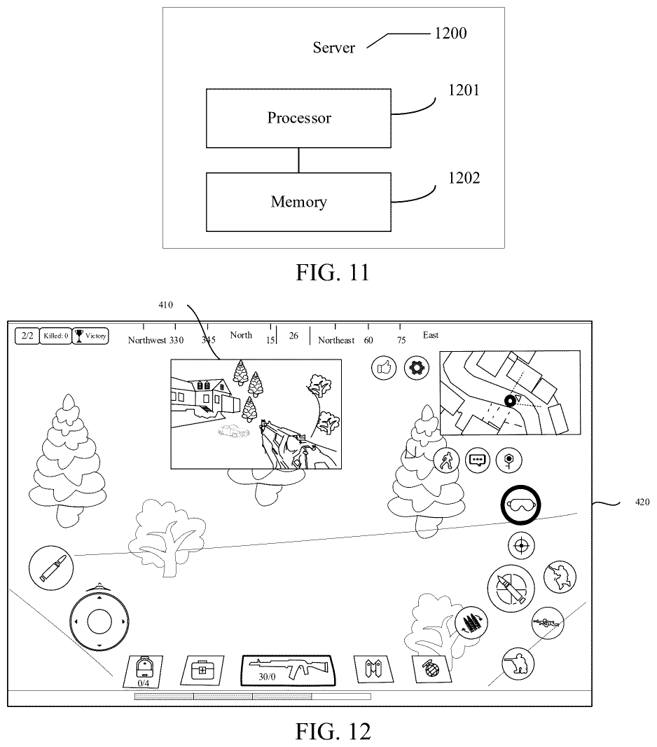

FIG. 12 is a schematic diagram of switching display areas of a target field-of-view picture and a first game picture according to an aspect of this disclosure. The fourth game picture shown in FIG. 12 is displayed in response to a drag operation performed on the first game picture 410 or the first target field-of-view picture 420 in FIG. 5. In FIG. 12, the first game picture 410 is superimposed on the first target field-of-view picture 420.

In this aspect of this disclosure, the picture display areas are switched to expand the target field-of-view picture, so that the user can view the target field-of-view picture and make an in-game decision based on content of the target field-of-view picture, thereby improving human-computer interaction efficiency and user experience.

In some aspects, after the second game picture is displayed, in response to a slide operation on the target field-of-view picture in the second game picture, a process in which transparency of the target field-of-view picture changes according to the slide operation is displayed; and a fifth game picture is displayed in response to that an end position of the slide operation is in the target field-of-view picture, where the fifth game picture includes the target field-of-view picture displayed above the first game picture with first transparency, and the first transparency is transparency obtained through adjustment based on the slide operation; or the target field-of-view picture with second transparency is displayed in the second game picture in response to that an end position of the slide operation is outside the target field-of-view picture, where the second transparency is transparency of the target field-of-view picture before the slide operation.

For example, the transparency means a degree to which each pixel in an image allows light to be transmitted through. The transparency describes how each point in the image blends with a background color or a lower-layer image. An area with high transparency allows more of the background color or the lower-layer image to be transmitted through, and seems to be more “transparent”; and an area with low transparency allows less of the background color to be transmitted through, and seems to be more “non-transparent”. The transparency of the target field-of-view picture may be adjusted by adjusting an Alpha channel value of the target field-of-view picture. The Alpha channel value ranges from 0 to 1. An Alpha channel value closer to 0 indicates higher transparency of the target field-of-view picture, and the first game picture below the target field-of-view picture is more capable of being displayed through the target field-of-view picture. Assuming that an upper edge and a lower edge of the target field-of-view picture are used as reference, a slide operation toward the upper edge increases the transparency of the target field-of-view picture, and a slide operation toward the lower edge decreases the transparency of the target field-of-view picture.

The end position of the slide operation is a position at which the slide operation stops or a position at which stay duration reaches preconfigured duration. If the end position of the slide operation is outside the target field-of-view picture, the user may accidentally trigger a function for adjusting the transparency, and the transparency of the target field-of-view picture may remain at the transparency before the slide operation is performed. If the end position of the slide operation is in the target field-of-view picture, the first transparency obtained through adjustment when the slide operation ends is used as the transparency of the target field-of-view picture, and the fifth game picture formed based on the target field-of-view picture with the first transparency is displayed.

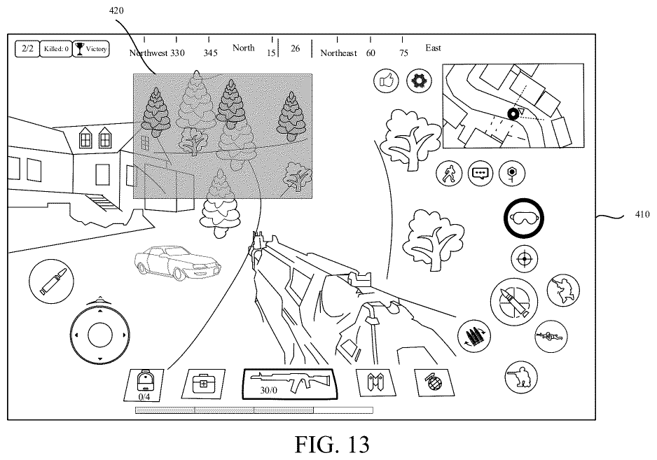

FIG. 13 is a schematic diagram of adjusting transparency of a target field-of-view picture according to an aspect of this disclosure. The first target field-of-view picture 420 above the first game picture 410 is displayed in a semi-transparent state, and content of the first game picture 410 below the first target field-of-view picture 420 is displayed through the first target field-of-view picture 420.

In this aspect of this disclosure, the transparency of the target field-of-view picture is adjusted through the slide operation, so that the first game picture can be displayed through the target field-of-view picture, and the user can freely adjust the transparency. Therefore, it is convenient for the user to observe both the first game picture and the target field-of-view picture, a field of view of the user is expanded, and convenience for the user to operate the virtual object can be improved, thereby improving human-computer interaction efficiency and game experience of the user.

In an example implementation of this disclosure, after the second game picture is displayed, generation time of the target field-of-view picture is further determined, and duration of the target field-of-view picture is calculated based on the generation time, where the duration is a difference between current time and the generation time; and a third game picture is displayed in response to that the duration is greater than or equal to reference duration, where the third game picture is a picture corresponding to the first field-of-view range of the virtual object at the current moment.

For example, the duration of the target field-of-view picture is the reference duration, and the reference duration is set by a server. When the duration of the target field-of-view picture is less than the reference duration, the second game picture is displayed, and the second game picture includes the picture corresponding to the first field-of-view range of the virtual object at the current moment and the target field-of-view picture. When the duration of the target field-of-view picture is greater than or equal to the reference duration, the third game picture is displayed, and the third game picture is the picture corresponding to the first field-of-view range of the virtual object at the current moment, in other words, displaying of the target field-of-view picture is canceled.

In an example implementation of this disclosure, after the second game picture is displayed, a state of the virtual object in the second game picture is further detected; and the third game picture is displayed in response to that the virtual object is detected in a second state, where the second state includes that the virtual object is in a dead state or in the vehicle-using state.

For example, in a process of displaying the target field-of-view picture, the state of the virtual object is detected in real time. If it is detected that the virtual object is killed to the ground or the virtual object dies, displaying of the target field-of-view picture is canceled. Alternatively, when it is detected that the virtual object starts to use a vehicle, displaying of the target field-of-view picture is canceled.

In an aspect of this disclosure, an application program in a client implements a use process of a virtual item by interacting with a server. FIG. 8 is a schematic diagram of an interaction process between an application program and a server according to an aspect of this disclosure. As shown in FIG. 8, trigger information for expanding a field-of-view range is generated in response to a use operation of a virtual item in the application program of a client, and the client sends a request for using the virtual item to the server. The request for using the virtual item may further include an identity document (ID) of a player and an ID of the virtual item. The server may verify the request for using the virtual item, for example, determine a first state of a virtual object. After the request for using the virtual item passes the verification, the server sends an instruction for delivering the virtual item. The instruction for delivering the virtual item sent by the server may further include related information of generating a target field-of-view picture.

After the client receives the instruction for delivering the virtual item, the virtual object may determine, based on the ID of the virtual item, that the virtual item can be used. After the player uses the virtual item, the client displays the target field-of-view picture and generates a special effect of using the virtual item. The server calculates duration of the target field-of-view picture. When the duration of the target field-of-view picture is greater than or equal to reference duration, the server sends an instruction for ending use of the virtual item to the client. After receiving the instruction for ending use of the virtual item, the client cancels displaying of the target field-of-view picture.

The virtual item provided in this aspect of this disclosure may be used as a tactical gameplay item. When the virtual object encounters an attack of another virtual object, the player may use the virtual item and view the target field-of-view picture. A second field-of-view range corresponding to the target field-of-view picture is different from a first field-of-view range of the virtual object in a current game picture. Therefore, the player can gain better awareness of a virtual environment around the virtual object, quickly adjust a position of the virtual object, and evade the attack of another virtual object. In addition, a position of another virtual object around the virtual object may be found quickly through the target field-of-view picture, to allow the virtual object to attack the another virtual object. Use of the virtual item may enrich game skills and improve interaction of the game, and is beneficial to bring a fresher feeling to the player, thereby improving game experience of the player.

This disclosure further provides a game control apparatus. FIG. 9 is a schematic diagram of a structure of a game control apparatus according to an aspect of this disclosure. As shown in FIG. 9, the apparatus includes:

a first display module 810, configured to display a first game picture, the first game picture including a picture corresponding to a first field-of-view range, and the first field-of-view range being a field-of-view range of a virtual object in a virtual environment; and

a second display module 830, configured to display a second game picture in response to a trigger operation on the first game picture,

the second game picture including the first game picture and a target field-of-view picture, the target field-of-view picture being determined based on a second field-of-view range and the virtual environment, the second field-of-view range being determined based on pose information of the virtual object, and the second field-of-view range being different from the first field-of-view range.

In some aspects, an obtaining module 820 is further configured to: before the second game picture is displayed, determine a field-of-view direction and position information of a first virtual camera based on the pose information of the virtual object, the pose information including an orientation of the virtual object, and an angle between the field-of-view direction and the orientation of the virtual object being a reference angle; obtain parameter information of the first virtual camera; and determine the second field-of-view range based on the parameter information and the position information of the first virtual camera and the field-of-view direction.

In some aspects, the second display module 830 is further configured to: obtain initial parameter information of the target field-of-view picture, the initial parameter information including at least one of a size of the target field-of-view picture or a position of the target field-of-view picture; superimpose the first game picture and the target field-of-view picture based on the initial parameter information of the target field-of-view picture, to obtain a superimposed picture, the target field-of-view picture being smaller than the first game picture, and the target field-of-view picture being above the first game picture; and adjust a rendering parameter of the superimposed picture, to obtain the second game picture.

In some aspects, the first game picture further includes a field-of-view control, and the first display module 810 is further configured to display the second game picture in response to the trigger operation on the field-of-view control in the first game picture.

In some aspects, the first display module 810 is further configured to: before the second game picture is displayed, detect a state of the field-of-view control, the state of the field-of-view control including a triggerable state; detect a trigger operation on the field-of-view control in response to that the field-of-view control is in the triggerable state; and perform an operation of displaying the second game picture in response to the trigger operation received by the field-of-view control and a use operation of a virtual item, the virtual item being generated based on the trigger operation on the field-of-view control.

In some aspects, the first display module 810 is further configured to: obtain energy of the virtual object and an energy threshold; control the field-of-view control to be in the triggerable state in response to that the energy of the virtual object is not less than the energy threshold, the field-of-view control in the triggerable state being configured to receive the trigger operation, and the trigger operation including any one of the following operations: a click/tap operation, a touch and hold operation, and a slide operation.

In some aspects, the first display module 810 is further configured to: obtain a first state of the virtual object, the first state being a state of the virtual object in the virtual environment at a current moment; and control the field-of-view control to be in a non-triggered state in response to that the first state of the virtual object meets an abnormal triggered state, the abnormal triggered state including at least one of the following: a knocked-down state, a vehicle-using state, a climbing state, or an awaiting rescue state.

In some aspects, the second display module 830 is further configured to: detect control information of the target field-of-view picture, the control information including at least one of the following: position movement information, picture zoom-in information, or picture zoom-out information; and control, in response to that the control information is detected, the target field-of-view picture based on the control information to perform a corresponding operation.

In some aspects, the second display module 830 is further configured to: determine generation time of the target field-of-view picture, and calculate duration of the target field-of-view picture based on the generation time, the duration being a difference between a current time and the generation time; and display a third game picture in response to that the duration is greater than or equal to reference duration, the third game picture being a picture corresponding to the first field-of-view range of the virtual object at the current moment.

In some aspects, the second display module 830 is further configured to: detect a state of the virtual object in the second game picture; and display the third game picture in response to that the virtual object is detected in a second state, the second state including that the virtual object is in a dead state or in a vehicle-using state.

In some aspects, the first display module 810 is further configured to: obtain initial pose information of the virtual object and parameter information of a second virtual camera, the initial pose information including at least one of initial position information, initial orientation information, or initial posture information of the virtual object in the virtual environment, and the second virtual camera being configured to generate a picture corresponding to the first field-of-view range; determine the first field-of-view range of the virtual object in the virtual environment based on the initial pose information and the parameter information of the second virtual camera; and display the first game picture based on the first field-of-view range.

In some aspects, the second display module 830 is further configured to: after the second game picture is displayed, exchange display areas of the target field-of-view picture and the first game picture in response to a switch operation on the target field-of-view picture in the second game picture, or in response to a switch operation on the first game picture in the second game picture, to form a fourth game picture, the fourth game picture including the superimposed picture of the first game picture and the target field-of-view picture, the first game picture being smaller than the target field-of-view picture, and the first game picture being above the target field-of-view picture.

In some aspects, the second display module 830 is configured to: after the second game picture is displayed, display, in response to a slide operation on the target field-of-view picture in the second game picture, a process in which transparency of the target field-of-view picture changes according to the slide operation; and display a fifth game picture in response to an end position of the slide operation on the target field-of-view picture, the fifth game picture including the target field-of-view picture displayed above the first game picture with first transparency, and the first transparency being transparency obtained through adjustment based on the slide operation; or display the target field-of-view picture with second transparency in the second game picture in response to that an end position of the slide operation is outside the target field-of-view picture, the second transparency being transparency of the target field-of-view picture before the slide operation.

In this disclosure, the target field-of-view picture corresponding to the second field-of-view range and the first game picture corresponding to the first field-of-view range are superimposed to obtain the second game picture, where the second field-of-view range is different from the first field-of-view range. The displayed field-of-view range is expanded, so that a player can better obtain virtual environment information around the virtual object based on the second game picture, and make an in-game decision promptly based on the virtual environment information, thereby improving game experience of the player.

When the apparatus provided above implements the functions of the apparatus, only division into the foregoing functional modules is used as an example for description. In the practical application, the functions may be allocated to and completed by different functional modules according to requirements. That is, an internal structure of the device is divided into different functional modules, to complete all or some of the functions described above. In addition, the apparatus and method aspects provided in the foregoing aspects belong to the same concept. For the specific implementation process, reference can be made to the method aspects. Details are not described herein again.

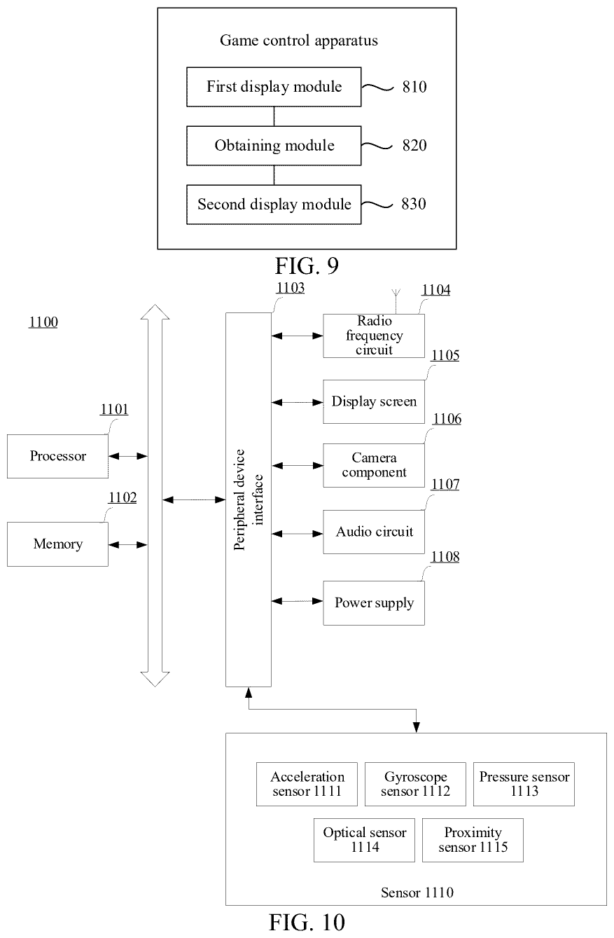

FIG. 10 is a block diagram of a structure of a terminal device 1100 according to an aspect of this disclosure. The terminal device 1100 is any electronic device product that may perform human-computer interaction with a user in one or more manners, such as through a keyboard, a touchpad, a touchscreen, a remote control, voice interaction, or a handwriting device. For example, the terminal device 1100 may be a personal computer (PC), a mobile phone, a smartphone, a personal digital assistant (PDA), a wearable device, a pocket PC (PPC), a tablet computer, a smart on-board unit, a smart television, a smart speaker, or a smart watch.

The terminal device 1100 includes a processor 1101 (an example of processing circuitry) and a memory 1102 (an example of a non-transitory computer-readable storage medium).

The processor 1101 may include one or more processing cores, for example, a four-core processor or an eight-core processor. The processor 1101 may be implemented in at least one hardware form of a digital signal processor (DSP), a field-programmable gate array (FPGA), or a programmable logic array (PLA). The processor 1101 may alternatively include a main processor and a coprocessor. The main processor is a processor configured to process data in an awake state, and is also referred to as a central processing unit (CPU). The coprocessor is a low-power consumption processor configured to process the data in a standby state. In some aspects, the processor 1101 may be integrated with a graphics processing unit (GPU). The GPU is configured to render and draw content that needs to be displayed on a display screen. In some aspects, the processor 1101 may further include an artificial intelligence (AI) processor. The AI processor is configured to process computing operations related to machine learning.

The memory 1102 may include one or more computer-readable storage media. The computer-readable storage medium may be non-transitory. The memory 1102 may further include a high-speed random access memory and a non-volatile memory, for example, one or more disk storage devices or flash storage devices. In some aspects, a non-transitory computer-readable storage medium in the memory 1102 is configured to store at least one instruction, and the at least one instruction is configured for being executed by the processor 1101, to implement the game control method provided in the method aspects of this disclosure.

In some aspects, the terminal device 1100 may alternatively include a peripheral device interface 1103 and at least one peripheral device. The processor 1101, the memory 1102, and the peripheral device interface 1103 may be connected through a bus or a signal cable. Each peripheral device may be connected to the peripheral device interface 1103 through a bus, a signal cable, or a circuit board. For example, the peripheral device includes at least one of a radio frequency circuit 1104, a display screen 1105, a camera component 1106, an audio circuit 1107, and a power supply 1108.

The peripheral device interface 1103 may be configured to connect at least one peripheral device related to input/output (I/O) to the processor 1101 and the memory 1102. In some aspects, the processor 1101, the memory 1102, and the peripheral device interface 1103 are integrated on a same chip or circuit board. In some other aspects, any one or two of the processor 1101, the memory 1102, and the peripheral device interface 1103 may be implemented on a single chip or circuit board, which is not limited in this aspect.

The radio frequency circuit 1104 is configured to receive and transmit a radio frequency (RF) signal, alternatively referred to as an electromagnetic signal. The radio frequency circuit 1104 communicates with a communication network and another communication device through the electromagnetic signal. The radio frequency circuit 1104 converts an electrical signal into an electromagnetic signal for transmission, or converts a received electromagnetic signal into an electrical signal. In some aspects, the radio frequency circuit 1104 includes an antenna system, an RF transceiver, one or more amplifiers, a tuner, an oscillator, a digital signal processor, a codec chip set, a subscriber identity module card, and the like. The radio frequency circuit 1104 may communicate with another terminal device by using at least one wireless communication protocol. The wireless communication protocol includes, but is not limited to, a world wide web, a metropolitan area network, an intranet, generations of mobile communication networks (2G, 3G, 4G, and 5G), a wireless local area network, and/or a Wi-Fi network. In some aspects, the radio frequency circuit 1104 may further include a circuit related to near field communication (NFC). This is not limited in this disclosure.

The display screen 1105 is configured to display a user interface (UI), which is briefly referred to as UI below. The UI may include a graph, text, an icon, a video, and any combination thereof. When the display screen 1105 is a touch display screen, the display screen 1105 further has a capability of collecting a touch signal on or above a surface of the display screen 1105. The touch signal may be input to the processor 1101 as a control signal for processing. In this case, the display screen 1105 may be further configured to provide a virtual button and/or a virtual keyboard that are/is also referred to as a soft button and/or a soft keyboard. In some aspects, there may be one display screen 1105 disposed on a front panel of the terminal device 1100. In some other aspects, there may be at least two display screens 1105 respectively disposed on different surfaces of the terminal device 1100 or designed in a foldable shape. In some other aspects, the display screen 1105 may be a flexible display screen disposed on a curved surface or a folded surface of the terminal device 1100. Even, the display screen 1105 may be further set in a non-rectangular irregular pattern, namely, a special-shaped screen. The display screen 1105 may be prepared by using materials such as a liquid crystal display (LCD) or an organic light-emitting diode (OLED).

The camera component 1106 is configured to acquire images or videos. In some aspects, the camera component 1106 includes a front-facing camera and a rear-facing camera. The front-facing camera is disposed on a front panel of the terminal device 1100, and the rear-facing camera is disposed on a back surface of the terminal device 1100. In some aspects, there are at least two rear-facing cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some aspects, the camera component 1106 may further include a flash. The flash may be a mono color temperature flash or a double color temperature flash. The double color temperature flash refers to a combination of a warm light flash and a cold light flash, and may be configured for light compensation under different color temperatures.

The audio circuit 1107 may include a microphone and a speaker. The microphone is configured to acquire acoustic waves of a user and an environment, and convert the acoustic waves into an electrical signal to input to the processor 1101 for processing, or input to the radio frequency circuit 1104 for implementing voice communication. For the purpose of stereo acquisition or noise reduction, there may be a plurality of microphones disposed at different portions of the terminal device 1100 respectively. The microphone may alternatively be an array microphone or an omni-directional acquisition type microphone. The speaker is configured to convert an electrical signal from the processor 1101 or the radio frequency circuit 1104 into acoustic waves. The speaker may be a conventional film speaker or a piezoelectric ceramic speaker. When the speaker is a piezoelectric ceramic speaker, the speaker not only can convert an electrical signal into acoustic waves audible to a human being, but also can convert an electrical signal into acoustic waves inaudible to a human being, for ranging and other purposes. In some aspects, the audio circuit 1107 may further include an earphone jack.

The power supply 1108 is configured to supply power to components in the terminal device 1100. The power supply 1108 may be an alternating current, a direct current, a primary battery, or a rechargeable battery. When the power supply 1108 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast-charging technology.

In some aspects, the terminal device 1100 further includes one or more sensors 1110. The one or more sensors 1110 include, but are not limited to, an acceleration sensor 1111, a gyroscope sensor 1112, a pressure sensor 1113, an optical sensor 1114, and a proximity sensor 1115.

The acceleration sensor 1111 may detect a magnitude of accelerations on three coordinate axes of a coordinate system established with the terminal device 1100. For example, the acceleration sensor 1111 is configured to detect components of gravity acceleration on the three coordinate axes. The processor 1101 may control, according to a gravity acceleration signal collected by the acceleration sensor 1111, the display screen 1105 to display the user interface in a landscape view or a portrait view. The acceleration sensor 1111 may be further configured to collect motion data of a game or a user.

The gyroscope sensor 1112 may detect a body direction and a rotation angle of the terminal device 1100. The gyroscope sensor 1112 may cooperate with the acceleration sensor 1111 to acquire a 3D action performed by a user on the terminal device 1100. The processor 1101 may implement the following functions according to the data collected by the gyroscope sensor 1112: motion sensing (for example, changing the UI according to a tilt operation of the user), image stabilization during shooting, game control, and inertial navigation.

The pressure sensor 1113 may be disposed on a side frame of the terminal device 1100 and/or a lower layer of the display screen 1105. When the pressure sensor 1113 is disposed on the side frame of the terminal device 1100, a holding signal of the user on the terminal device 1100 may be detected. The processor 1101 performs left and right hand recognition or a quick operation according to the holding signal acquired by the pressure sensor 1113. When the pressure sensor 1113 is disposed on the lower layer of the display screen 1105, the processor 1101 controls an operable control on the UI interface according to a pressure operation performed by the user on the display screen 1105. The operable control includes at least one of a button control, a scroll-bar control, an icon control, and a menu control.

The optical sensor 1114 is configured to acquire an ambient light intensity. In an aspect, the processor 1101 may control display brightness of the display screen 1105 according to the ambient light intensity acquired by the optical sensor 1114. For example, when the ambient light intensity is relatively high, the display brightness of the display screen 1105 is increased. When the ambient light intensity is relatively low, the display brightness of the display screen 1105 is decreased. In another aspect, the processor 1101 may further dynamically adjust photographing parameters of the camera component 1106 according to the ambient light intensity acquired by the optical sensor 1114.

The proximity sensor 1115, also referred to as a distance sensor, is disposed on the front panel of the terminal device 1100. The proximity sensor 1115 is configured to acquire a distance between the user and a front surface of the terminal device 1100. In an aspect, when the proximity sensor 1115 detects that the distance between the user and the front surface of the terminal device 1100 decreases gradually, the display screen 1105 is controlled by the processor 1101 to switch from a screen-on state to a screen-off state. When the proximity sensor 1115 detects that the distance between the user and the front surface of the terminal device 1100 increases gradually, the display screen 1105 is controlled by the processor 1101 to switch from a screen-off state to a screen-on state.

It is noted that the structure shown in FIG. 10 does not constitute a limitation to the terminal device 1100, and the terminal device 1100 may include more or fewer components than those shown in the figure, or some components may be combined, or different component arrangements may be used.

FIG. 11 is a schematic diagram of a structure of a server according to an aspect of this disclosure. A server 1200 may vary a lot due to different configurations or performance, and may include one or more processors (Central Processing Units, CPUs) 1201 and one or more memories 1202. The one or more memories 1202 store at least one piece of program code, and the at least one piece of program code is loaded and executed by the one or more processors 1201 to implement the game control method provided in the foregoing method aspects. The server 1200 may further include components such as a wired or wireless network interface, a keyboard, and an input/output interface, to facilitate input and output. The server 1200 may further include another component configured to implement a function of a device. Details are not described herein.

In an aspect, a non-transitory computer-readable storage medium is further provided. The storage medium stores at least one piece of program code, and the at least one piece of program code is loaded and executed by a processor, to enable a computer to implement any one of the foregoing game control methods.

In some aspects, the computer-readable storage medium may be a read-only memory (ROM), a random access memory (RAM), a compact disc read-only memory (CD-ROM), a magnetic tape, a floppy disk, an optical data storage device, or the like.

In an aspect, a computer program or a computer program product is further provided. The computer program or the computer program product stores at least one computer instruction, and the at least one computer instruction is loaded and executed by a processor, to enable a computer to implement any one of the foregoing game control methods.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

“A plurality of” mentioned in this specification means two or more. The term “and/or” describes an association relationship for describing associated objects and represents that three relationships may exist. For example, A and/or B may represent the following three cases: Only A exists, both A and B exist, and only B exists. The character “/” indicates an “or” relationship between the associated objects.

The foregoing descriptions are merely example aspects of this disclosure, and are not intended to limit this disclosure. Any modification, equivalent replacement, or improvement made within the principle of this disclosure shall fall within the scope of this disclosure.

What is claimed is:

1. A game control method, comprising:
outputting for display a first virtual scene of a virtual environment according to a first field-of-view of a virtual character located in the virtual environment;
determining that a trigger operation is performed to display a plurality of fields-of-view of the virtual character; and
based on the trigger operation, outputting for display a second virtual scene of the virtual environment according to a second field-of-view of the virtual character concurrently with the first virtual scene, wherein
the second field-of-view is different from the first field-of-view.

2. The method according to claim 1, further comprising:
determining the second field-of-view of the virtual character based on a viewing direction and a camera position associated with the virtual character.

3. The method according to claim 1, wherein the outputting for display the second virtual scene comprises:
outputting for display the second virtual scene as an overlay over a portion of the first virtual scene, a display size of the second virtual scene being smaller than a display size of the first virtual scene.

4. The method according to claim 1, further comprising:
outputting for display a user interface that includes a field-of-view control element, wherein
the trigger operation is performed on the field-of-view control element in the user interface.

5. The method according to claim 4, further comprising:
determining that the trigger operation is performed when the field-of-view control element is in a triggerable state.

6. The method according to claim 5, further comprising:
determining a resource value of the virtual character; and
when the resource value of the virtual character is greater than or equal to a resource threshold, determining that the field-of-view control element is in the triggerable state.

7. The method according to claim 5, further comprising:
determining a current state of the virtual character in the virtual environment; and
when the current state satisfies a restricted activation condition, determining that the field-of-view control element is in an inactive state.

8. The method according to claim 1, further comprising:
receiving control input operation that is performed on the display of the second virtual scene, the control input operation indicating at least one of: a position movement, a zoom-in operation, or a zoom-out operation; and
adjusting the display of the second virtual scene based on the control input operation.

9. The method according to claim 1, further comprising:
determining an active duration of the display of the second virtual scene; and
when the active duration is greater than or equal to a threshold duration, stopping the concurrent display of the second virtual scene with the first virtual scene.

10. The method according to claim 1, further comprising:
determining a current state of the virtual character; and
when the current state corresponds to a predefined state, stopping the concurrent display of the second virtual scene with the first virtual scene.

11. The method according to claim 1, wherein the outputting for display the first virtual scene comprises:
determining the first field-of-view based on initial pose information of the virtual character and parameters of a virtual camera; and
outputting for display the first virtual scene based on the first field-of-view.

12. The method according to claim 1, further comprising:
determining that a switch operation is performed to switch the displays of the first virtual scene according to the first field-of-view and the second virtual scene according to the second field-of-view; and
based on the switch operation being performed, exchanging display positions of the first virtual scene and the second virtual scene such that the first virtual scene is overlaid over the second virtual scene.

13. The method according to claim 1, further comprising:
determining that a slide operation is performed on the display of the second virtual scene;
adjusting a transparency value of the second virtual scene based on the slide operation; and
outputting for display the second virtual scene with the adjusted transparency value.

14. A game control apparatus, comprising:
processing circuitry configured to:
output for display a first virtual scene of a virtual environment according to a first field-of-view of a virtual character located in the virtual environment;
determine that a trigger operation is performed to display a plurality of fields-of-view of the virtual character; and
based on the trigger operation, output for display a second virtual scene of the virtual environment according to a second field-of-view of the virtual character concurrently with the first virtual scene, wherein
the second field-of-view is different from the first field-of-view.

15. The apparatus according to claim 14, wherein the processing circuitry is configured to:
determine the second field-of-view of the virtual character based on a viewing direction and a camera position associated with the virtual character.

16. The apparatus according to claim 14, wherein the processing circuitry is configured to:
output for display the second virtual scene as an overlay over a portion of the first virtual scene, a display size of the second virtual scene being smaller than a display size of the first virtual scene.

17. The apparatus according to claim 14, wherein the processing circuitry is configured to:
output for display a user interface that includes a field-of-view control element, wherein
the trigger operation is performed on the field-of-view control element in the user interface.

18. The apparatus according to claim 17, wherein the processing circuitry is configured to:
determine that the trigger operation is performed when the field-of-view control element is in a triggerable state.

19. The apparatus according to claim 18, wherein the processing circuitry is configured to:
determine a resource value of the virtual character; and
when the resource value of the virtual character is greater than or equal to a resource threshold, determine that the field-of-view control element is in the triggerable state.

20. A non-transitory computer-readable storage medium storing instructions which, when executed by a processor, cause the processor to perform:
outputting for display a first virtual scene of a virtual environment according to a first field-of-view of a virtual character located in the virtual environment;
determining that a trigger operation is performed to display a plurality of fields-of-view of the virtual character; and
based on the trigger operation, outputting for display a second virtual scene of the virtual environment according to a second field-of-view of the virtual character concurrently with the first virtual scene, wherein
the second field-of-view is different from the first field-of-view.
